(19) United States
(12) Patent Application Publication
(10) Pub. No.: US 2024/0390218 A1
(43) Pub. Date: Nov. 28, 2024

(54) Back Massaging Assembly

(71) Applicant: Colby Berry, Midland, TX (US)

(72) Inventor: Colby Berry, Midland, TX (US)

(21) Appl. No.: 18/201,153

(22) Filed: May 23, 2023

(51) Int. Cl. A61H 15/00

(52) U.S. Cl. CPC A61H 15/0092; A61H 2015/0014; A61H 2201/0153; A61H 2205/081

(57) ABSTRACT

A back massaging assembly includes a panel that has a pair of rails that is each attached to the panel. A pair of retractors is each coupled to the panel and a pair of belts is each attached to a respective one of the retractors. A pair of handles is each attached to a respective one of the belts for gripping by a user to position the panel on the user's back. A plurality of massaging units is provided and a respective one of the plurality of massaging units is attachable to the pair rails on the panel. In this way the respective massaging unit can positioned against the user's back when the user grips the handles to massage their back.

### (b) CROSS-REFERENCE TO RELATED APPLICATIONS

### Not Applicable

### (c) STATEMENT REGARDING FEDERALLY SPONSORED RESEARCH OR DEVELOPMENT

### Not Applicable

### (d) THE NAMES OF THE PARTIES TO A JOINT RESEARCH AGREEMENT

### Not Applicable

### (e) INCORPORATION-BY-REFERENCE OF MATERIAL SUBMITTED ON A COMPACT DISC OR AS A TEXT FILE VIA THE OFFICE ELECTRONIC FILING SYSTEM

### Not Applicable

### (f) STATEMENT REGARDING PRIOR DISCLOSURES BY THE INVENTOR OR JOINT INVENTOR

### Not Applicable

### (g) BACKGROUND OF THE INVENTION

### (1) Field of the Invention

The disclosure relates to massaging devices and more particularly pertains to a new massaging device for facilitating a user to massage their back and to apply skin lotion to their back. The device includes a panel, a pair of rails attached to the panel, a pair of retractors each attached to the panel and a pair of belts each retractably integrated into a respective one of the retractors. The device includes a plurality of massaging units, each of which includes a respective type of massaging elements for performing various types of massaging techniques.

### (2) Description of Related Art Including Information Disclosed Under 37 CFR 1.97 and 1.98.

The prior art relates to massaging devices including a variety of back washing devices that each at least includes a strip, a pair of handles attached to the strip and a scrubber attached to the strips for scrubbing a user's back. The prior art discloses a variety of lotion application devices that each at least includes a strip which is comprised of a fluid absorbent material for absorbing body lotion and a pair of handles disposed on the strip to facilitate the strip to apply to body lotion to a user's back. The prior art discloses a lotion application device that includes a strip, a pair of loops attached to the strip and a plurality of applicator pads that can each be extended beneath the pair of loops to applying lotion to a user's back.

### (h) BRIEF SUMMARY OF THE INVENTION

An embodiment of the disclosure meets the needs presented above by generally comprising a panel that has a pair of rails that is each attached to the panel. A pair of retractors is each coupled to the panel and a pair of belts is each attached to a respective one of the retractors. A pair of handles is each attached to a respective one of the belts for gripping by a user to position the panel on the user's back. A plurality of massaging units is provided and a respective one of the plurality of massaging units is attachable to the pair rails on the panel. In this way the respective massaging unit can positioned against the user's back when the user grips the handles to massage their back.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### (i) BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front view of a back massaging assembly according to an embodiment of the disclosure.

FIG. 2 is a top perspective view of an embodiment of the disclosure.

FIG. 3 is a top view of an embodiment of the disclosure.

FIG. 4 is a perspective in-use view of an embodiment of the disclosure.

FIG. 5 is an exploded perspective view of an embodiment of the disclosure.

FIG. 6 is perspective view of a massaging unit of an embodiment of the disclosure.

FIG. 7 is a phantom view of a retractor and a belt of an embodiment of the disclosure.

### (j) DETAILED DESCRIPTION OF THE INVENTION

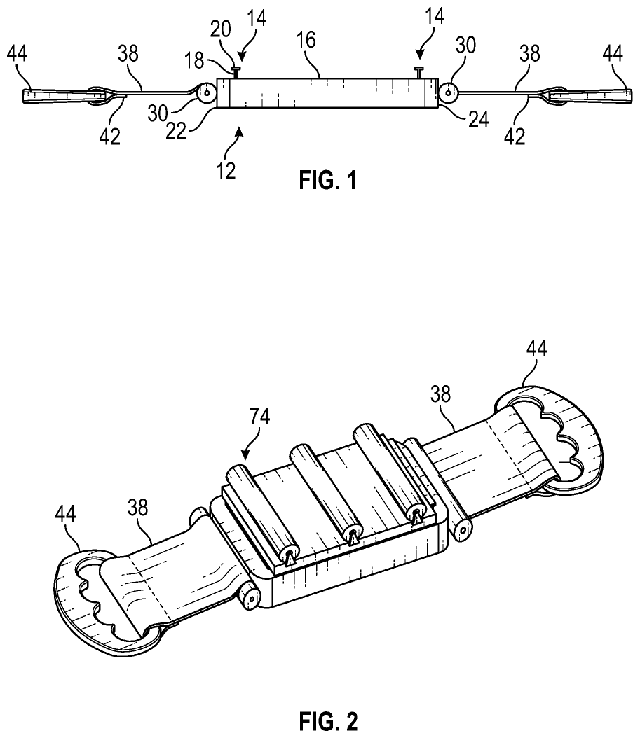

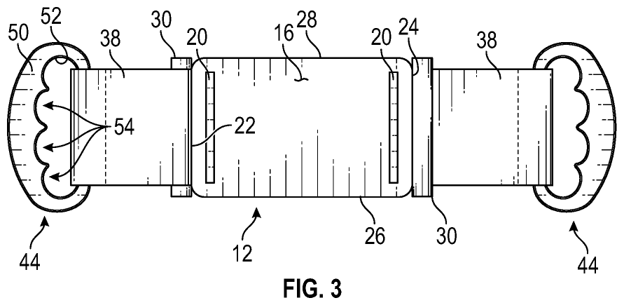

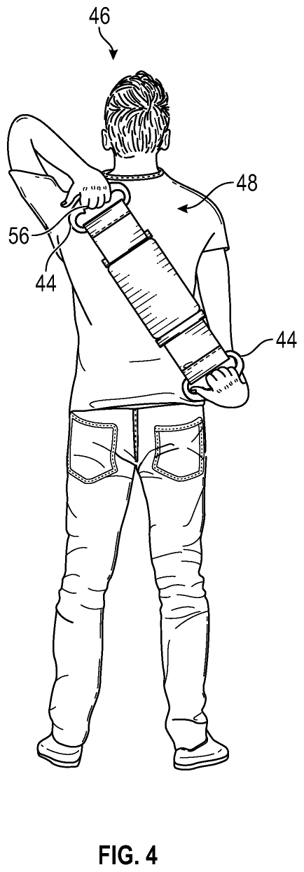

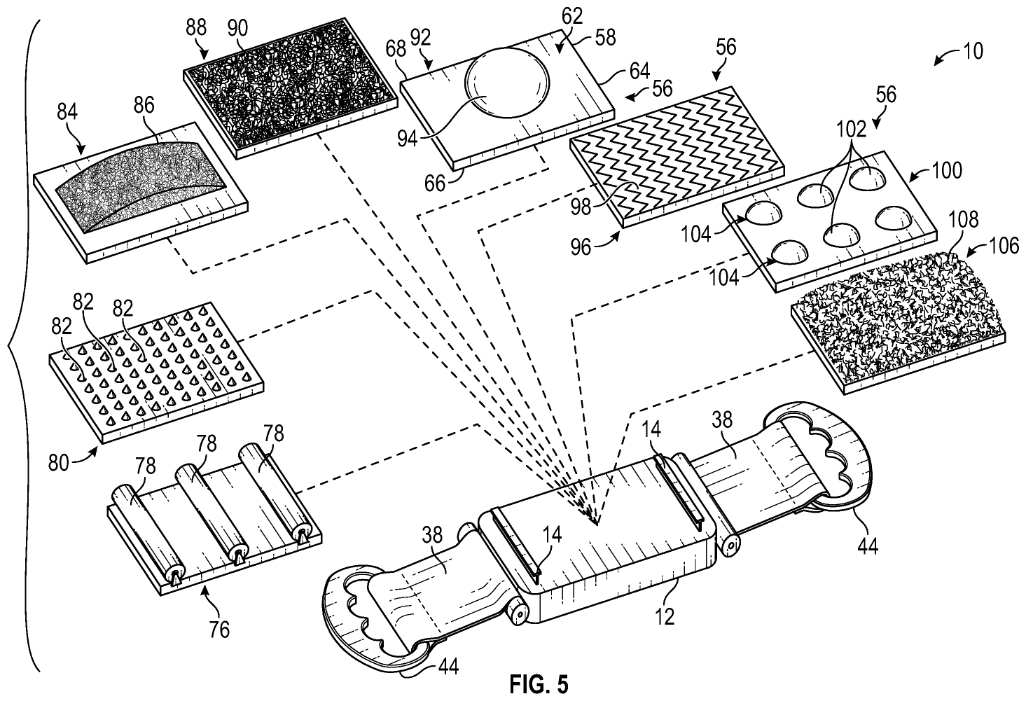

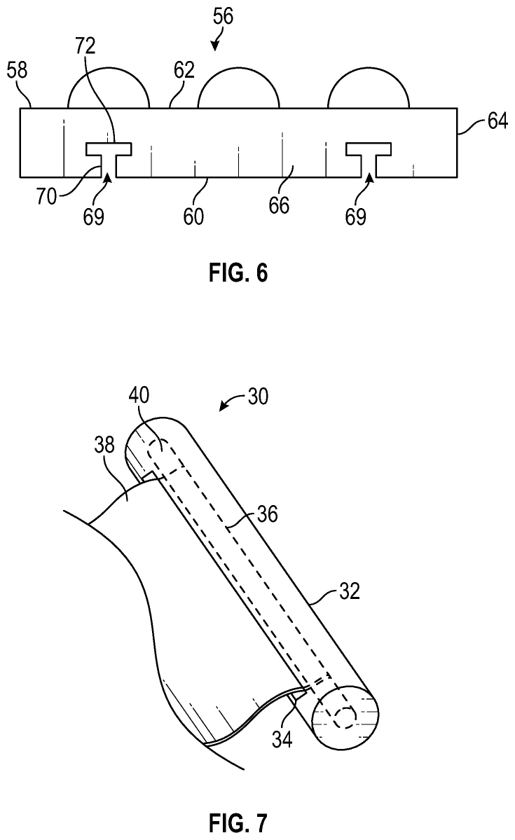

With reference now to the drawings, and in particular to FIGS. 1 through 7 thereof, a new massaging device embodying the principles and concepts of an embodiment of the disclosure and generally designated by the reference numeral 10 will be described.

As best illustrated in FIGS. 1 through 7, the back massaging assembly 10 generally comprises a panel 12 that has a pair of rails 14 that is each attached to the panel 12 and each of the rails 14 is positioned on an upper surface 16 of the panel 12. Each of the rails 14 has a stem 18 extending upwardly from the upper surface 16 and a head 20 that is oriented transverse with the stem 18 such that each of the rails 14 has a T-shape. Each of the rails 14 is spaced from a respective one of a first lateral side 22 and a second lateral side 24 of the panel 12 and each of the rails 14 is elongated to extend substantially between a front side 26 and a back side 28 of the panel 12.

A pair of retractors 30 is provided and each of the retractors 30 is coupled to the panel 12. Each of the retractors 30 includes a canister 32 that is disposed on a respective one of the first lateral side 22 and the second lateral side 24 of the panel 12. The canister 32 associated with each of the retractors 30 is elongated to extend substantially between the front side 26 and the back side 28 of the panel 12. The canister 32 associated with each of the retractors 30 has a opening 34 extending into an interior of the canister 32 and each of the retractors 30 includes a spool 36 that is disposed within the canister 32. The spool 36 associated with each the retractors 30 is biased to rotate in a first direction and the spool 36 associated with each of the retractors 30 is rotatable in a second direction.

A pair of belts 38 is each attached to a respective one of the retractors 30 and each of the belts 38 is urgeable outwardly from the respective retractor 30 to a selected length. Each of the belts 38 is retracted into the retractors 30 for storage and each of the belts 38 extends through the opening 34 in the canister 32 associated with the respective retractor 30. Each of the belts 38 has a first end 40 that is attached to the spool 36 in the canister 32 associated with the respective retractor 30. Additionally, each of the belts 38 has a second end 42 that is positioned outside of the canister 32 associated with the respective retractor 30. Each of the belts 38 may be comprised of a flexible material, including but not being limited to, nylon or canvas.

A pair of handles 44 is each attached to a respective one of the belts 38 such that each of the handles 44 can be gripped by a user 46 thereby facilitating the panel 12 to be positioned on the user's back 48. Each of the handles 44 comprises an annular ring 50 such that each of the handles 44 has a circular shape that is elongated along a lateral axis such that each of the handles 44 has an ovoid shape. The annular ring 50 has an interior edge 52 and the interior edge 52 has a plurality of depressions 54 that are spaced apart from each other to accommodate the user's fingers 56 for gripping the annular ring 50. The annular ring 50 is oriented on the respective belt 38 such that the plurality of depressions 54 is directed toward the respective belt 38 and each of the handles 44 is disposed on the second end 42 of the respective belt 38. The respective belt 38 may be wrapped around the respective handle 44 and the second end 42 of the respective belt 38 may be attached to the respective belt 38 for securing the respective belt 38 to the respective handle 44.

A plurality of massaging units 56 is provided and a respective one of the plurality of massaging units 56 is attachable to the pair of rails 14 on the panel 12. In this way the respective massaging unit 56 can be positioned against the user's back 48 when the user 46 grips the handles 44 thereby facilitating the user 46 to massage their back 48. Each of the plurality of massaging units 56 comprises a plate 58 that has a bottom surface 60, a top surface 62 and a perimeter edge 64 extending between the top surface 62 and the bottom surface 60. The perimeter edge 64 has a front side 66 and a back side 68 and the plate 58 has a pair of slots 69 each extending through the front side 66 and the back side 68. Each of the slots 69 has a first portion 70 extending from the bottom surface 60 toward the top surface 62. Furthermore, each of the slots 69 has a second portion 72 that is transversely oriented with the first portion 70 such that each of the slots 69 has a T-shape. Each of the slots 69 insertably receives a respective one of the rails 14 having the stem 18 of the rails 14 being positioned in the first portion 70 and having the head 20 of the rails 14 is positioned in the second portion 72.

Each of the massaging units 56 includes a massaging element 74 that is attached to the top surface 62 of the plate 58. In this way the massaging element 74 can be positioned against the user's back 48 thereby facilitating the massaging element 74 to massage the user's back 48. The plurality of massaging units 56 includes a roller unit 76 and the massaging element 74 associated with the roller unit 76 includes a plurality of rollers 78 that are each rotatably attached to the top surface 62 of the plate 58. In this way the rollers 78 can be rolled along the user's back 48 to massage the user's back 48. The plurality of massaging elements 56 includes a scratch unit 80 and the massaging element 74 associated with the scratch unit 80 includes a plurality of cones 82 extending upwardly from the top surface 62 of the plate 58 thereby facilitating the plurality of cones 82 to scratch the user's back 48. The plurality of massaging units 56 includes a lotion unit 84 and the massaging element 74 of the lotion unit 84 comprises a pad 86 which arches upwardly from the top surface 62 of the plate 58. The pad 86 is comprised of a fluid absorbent material to facilitate the pad 86 to absorb body lotion and subsequently apply the body lotion to the user's back 48.

The plurality of massaging units 56 includes a loofah unit 88 and the massaging element 74 of the loofah unit 88 comprises a loofah pad 90 attached to the top surface 62 of the plate 58 for exfoliating the user's back 48. The plurality of massaging units 56 includes a large ball unit 92 and the massaging element 74 of the large ball unit 92 comprises a dome 94 extending upwardly from the top surface 62 of the plate 58. The dome 94 is comprised of a rigid material thereby facilitating the dome 94 to massage muscles in the user's back 48. The plurality of massaging units 56 includes a zig zag unit 96 and the massaging element 74 of the zig zag unit 96 comprises a pad 98 attached to the top surface 62 of the plate 58 and the pad 98 associated with the zig zag unit 96 is textured with a zig zag pattern for scratching the user's back 48. The plurality of massaging units 56 includes small ball unit 100 and the massaging element 74 of the small ball unit 100 comprises a plurality of domes 102 each extending upwardly from the top surface 62 of the plate 58. The plurality of domes 102 are arranged in a pair of rows 104 on the top surface 62 and each of the plurality of domes 102 are comprised of a rigid material thereby facilitating the plurality of domes 102 to massage muscles in the user's back 48. The plurality of massaging units 56 includes a scratch block unit 106 and the massaging element 74 of the scratch block unit 106 comprises a pad 108 attached to the top surface 62 of the plate 58 which is comprised of an abrasive material to facilitate the pad 108 associated with the scratch block unit 106 to exfoliate the user's back 48.

In use, a respective one of the massaging units 56 is attached to the pair of rails 14 and each of the handles 44 is gripped to draw the belts 38 outwardly from the retractors 30. The panel 12 is positioned on the user's back 48 such that the respective massaging unit 56 is positioned against the user's back 48. In this way the user 46 can move the respective massaging unit 56 across their back 48 to massage their back 48, exfoliate their back 48 or apply body lotion to their back, depending upon which of the plurality of massaging units 56 is attached to the panel 12. Additionally, the plurality of massaging units 56 can be interchanged at any time to facilitate the user 46 to massage their back 48 in a variety of different ways and to apply body lotion, for example, subsequent to massaging their back 48.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A back massaging assembly for facilitating a user to massage hard to reach places on their back, said assembly comprising:
a panel having a pair of rails each being attached to said panel;
a pair of retractors, each of said retractors being coupled to said panel;
a pair of belts, each of said belts being attached to a respective one of said retractors, each of said belts being urgeable outwardly from said respective retractor to a selected length, each of said belts being retracted into said retractors for storage;
a pair of handles, each of said handles being attached to a respective one of said belts wherein each of said handles is configured to be gripped by a user thereby facilitating said panel to be positioned on the user's back; and
a plurality of massaging units, a respective one of said plurality of massaging units being attachable to said pair of rails on said panel wherein said respective massaging unit is configured to be positioned against the user's back when the user grips said handles thereby facilitating the user to massage their back.

2. The assembly according to claim 1, wherein each of said rails is positioned on an upper surface of said panel, each of said rails having a stem extending upwardly from said upper surface and a head being oriented transverse with said stem such that each of said rails has a T-shape, each of said rails being spaced from a respective one of a first lateral side and a second lateral side of said panel, each of said rails being elongated to extend substantially between a front side and a back side of said panel.

3. The assembly according to claim 2, wherein:
each of said retractors includes:
a canister being disposed on a respective one of said first lateral side and said second lateral side of said panel, said canister associated with each of said retractors being elongated to extend substantially between said front side and said back side of said panel, said canister associated with each of said retractors having an opening extending into an interior of said canister; and
a spool being disposed within said canister, said spool associated with each said retractors being biased to rotate in a first direction, said spool associated with each of said retractors being rotatable in a second direction; and
each of said belts extends through said opening in said canister associated with said respective retractor, each of said belts having a first end being attached to said spool in said canister associated with said respective retractor, each of said belts having a second end being positioned outside of said canister associated with said respective retractor.

4. The assembly according to claim 3, wherein each of said handles comprises an annular ring such that each of said handles has a circular shape being elongated along a lateral axis such that each of said handles has an ovoid shape, said annular ring having an interior edge, said interior edge having a plurality of depressions being spaced apart from each other wherein said plurality of depressions is configured to accommodate the user's fingers for gripping said annular ring, said annular ring being oriented on said respective belt such that said plurality of depressions is directed toward said belt, each of said handles being disposed on said second end of said respective belt.

5. The assembly according to claim 2, wherein each of said plurality of massaging units comprises a plate having a bottom surface, a top surface and a perimeter edge extending between said top surface and said bottom surface, said perimeter edge having a front side and a back side, said plate having a pair of slots each extending through said front side and said back side, each of said slots having a first portion extending from said bottom surface toward said top surface, each of said slots having a second portion being transversely oriented with said first portion such that each of said slots has a T-shape, each of said slots insertably receiving a respective one of said rails having said stem of said rails being positioned in said first portion and having said head of said rails being positioned in said second portion.

6. The assembly according to claim 5, wherein each of said plurality of massaging units includes a massaging element being attached to said top surface of said plate wherein said massaging element is configured to be positioned against the user's back thereby facilitating said massaging element to massage the user's back.

7. A back massaging assembly for facilitating a user to massage hard to reach places on their back, said assembly comprising:
a panel having a pair of rails each being attached to said panel, each of said rails being positioned on an upper surface of said panel, each of said rails having a stem extending upwardly from said upper surface and a head being oriented transverse with said stem such that each of said rails has a T-shape, each of said rails being spaced from a respective one of a first lateral side and a second lateral side of said panel, each of said rails being elongated to extend substantially between a front side and a back side of said panel;
a pair of retractors, each of said retractors being coupled to said panel, each of said retractors including a canister being disposed on a respective one of said first lateral side and said second lateral side of said panel, said canister associated with each of said retractors being elongated to extend substantially between said front side and said back side of said panel, said canister associated with each of said retractors having an opening extending into an interior of said canister, each of said retractors including a spool being disposed within said canister, said spool associated with each said retractors being biased to rotate in a first direction, said spool associated with each of said retractors being rotatable in a second direction;
a pair of belts, each of said belts being attached to a respective one of said retractors, each of said belts being urgeable outwardly from said respective retractor to a selected length, each of said belts being retracted into said retractors for storage, each of said belts extending through said opening in said canister associated with said respective retractor, each of said belts having a first end being attached to said spool in said canister associated with said respective retractor, each of said belts having a second end being positioned outside of said canister associated with said respective retractor;
a pair of handles, each of said handles being attached to a respective one of said belts wherein each of said handles is configured to be gripped by a user thereby facilitating said panel to be positioned on the user's back, each of said handles comprising an annular ring such that each of said handles has a circular shape being elongated along a lateral axis such that each of said handles has an ovoid shape, said annular ring having an interior edge, said interior edge having a plurality of depressions being spaced apart from each other wherein said plurality of depressions is configured to accommodate the user's fingers for gripping said annular ring, said annular ring being oriented on said respective belt such that said plurality of depressions is directed toward said belt, each of said handles being disposed on said second end of said respective belt; and
a plurality of massaging units, a respective one of said plurality of massaging units being attachable to said pair of rails on said panel wherein said respective massaging unit is configured to be positioned against the user's back when the user grips said handles thereby facilitating the user to massage their back, each of said plurality of massaging units comprising:
a plate having a bottom surface, a top surface and a perimeter edge extending between said top surface and said bottom surface, said perimeter edge having a front side and a back side, said plate having a pair of slots each extending through said front side and said back side, each of said slots having a first portion extending from said bottom surface toward said top surface, each of said slots having a second portion being transversely oriented with said first portion such that each of said slots has a T-shape, each of said slots insertably receiving a respective one of said rails having said stem of said rails being positioned in said first portion and having said head of said rails being positioned in said second portion; and
a massaging element being attached to said top surface of said plate wherein said massaging element is configured to be positioned against the user's back thereby facilitating said massaging element to massage the user's back.
